(19) United States
(12) Patent Application Publication
(10) Pub. No.: US 2005/0231089 A1
(43) Pub. Date: Oct. 20, 2005

(54) Mesh structure of tetraode field-emission display and method of fabricating the same

(76) Inventors: Kuo-Rong Chen, Guanyin Township (TW); Te-Fong Chan, Guanyin Township (TW); Kuei-Wen Cheng, Guanyin Township (TW)

Correspondence Address: Yi-Wen Tseng, 4331 Stevens Battle Lane, Fairfax, VA, 22033, US

(21) Appl. No.: 10/823,759

(22) Filed: Apr. 14, 2004

(51) Int. Cl. H01J 21/10; H01J 1/46; H01J 9/24

(52) U.S. Cl. 313/303; 313/495; 313/293; 445/24

(57) ABSTRACT

A mesh structure of tetraode field-emission display and a method of fabricating the same are disclosed. The mesh has a gate layer, an insulation layer, a converging electrode layer and a glass plate. The converging electrode layer fabricated from a metal conductive plate is adhered on the glass plate. The insulation layer is formed on the converging electrode layer and a conductive layer is formed on the insulation layer. The glass plate serves as a spacer, and the conductive layer serves as the gate layer. The spacing glass plate, the converging electrode layer, the insulation layer and the gate layer are perforated with at least one aperture to establish a path of electron beam between an anode and a cathode of the tetraode field-emission display.

### BACKGROUND OF THE INVENTION

The present invention relates in general to a field-emission display, and more particular, to a tetra-layer mesh structure of the tetraode field-emission display and a method of fabricating the same.

The field-emission display is a very newly developed technology. Being self-illuminant, such type of display does not require a back light source like the liquid crystal display. In addition to the better brightness, the viewing angle is broader, power consumption is lower, response speed is faster (no residual image), and the operation temperature range is larger. The image quality of the field-emission display is similar to that of the conventional cathode ray tube (CRT) display, while the dimension of the field-emission display is much thinner and lighter compared to the cathode ray tube display. Therefore, it is foreseeable that the field-emission display may replace the liquid crystal display in the market. Further, the fast growing nanotechnology enables nano-material to be applied in the field-emission display, such that the technology of field-emission display will be commercially available.

FIG. 1 shows a conventional triode field-emission display, which includes an anode plate 10 and a cathode plate 20. A spacer 14 is placed in the vacuum region between the anode plate 10 and the cathode plate 20 to provide isolation and support thereof. The anode plate 10 includes an anode substrate 11, an anode conductive layer 12 and a phosphor layer 13. The cathode plate 20 includes a cathode substrate 21, a cathode conductive layer 22, an electron emission layer 23, a dielectric layer 24 and a gate layer 25. A potential difference is provided to the gate layer 25 to induce electron beam emission from the electron emission layer 23. The high voltage provided by the anode conductive layer 12 accelerates the electron beam with sufficient momentum to impinge the phosphors layer 13 of the anode plate 10, which is then excited to emit a light. To allow electron moving in the field-emission display, the vacuum is maintained at least under 10⁻⁵ torr, such that a proper mean free path of the electron is obtained. In addition, contamination and poison of the electron emission source and the phosphors layer have to be avoided. Further, the electron emission layer 23 and the phosphors layer 13 have to be spaced from each other by a predetermined distance for accelerating the electron with the energy required to generate light from the phosphors layer 13.

The electron beam emitted by the conventional structure is typically in a fan configuration, and the diverging range of such electron beam is difficult to control by the triode field-emission display. The electron beam is easily excessively divergent and may even impinge the phosphors layer 33 of the neighboring unit to degrade the display effect. Therefore, a tetra-polar structure is proposed as shown in FIG. 2. In the tetra-polar structure, a fourth electrode, that is, the converging electrode is formed in addition to the triode structure. A mesh 5 is formed between the cathode plate 40 and the anode plate 30. The mesh 5 includes a converging electrode layer 51, an insulation layer 52 and a gate layer 53. The converging electrode layer 51 is proximal to the anode plate 30, the gate layer 53 is proximal to the cathode plate 40, and the insulation layer 52 is sandwiched between the converging electrode layer 51 and the gate layer 53. An isolation wall 44 is formed to extend between the gate layer 53 and the cathode layer 40. The cathode plate 40 includes a cathode substrate 41, a cathode conductive layer 42 and an electron emission source layer 43. The gate layer 53 and the converging electrode layer 51 carries adequate potentials. A plurality of apertures 54 is formed to extend through the mesh 5. Each of the apertures 54 is aligned with a corresponding unit of anode and cathode, such that electron beam generated from the electron emission source layer 43 can propagate towards the phosphor layer 33. The structure of the mesh 5 is illustrated in FIG. 3. As shown, a metal conductive plate is used as a base of the mesh 5. That is, the converging electrode layer 51 fabricated from the metal conductive plate. The insulation layer 52 is formed on the bottom surface of the metal conductive layer. A conductive layer is then formed on the bottom surface of the insulation layer 52 to serve as the gate layer 53. The metal conductive plate is processed to form an array of through apertures 54. The position of each aperture 54 is aligned with each unit of anode and cathode formed on the anode and cathode plates 30 and 40, respectively. The apertures 54 serve as emission channel for the electron beam emitted from each cathode. The periphery of the metal conductive plate is an inoperative region 55. A plurality of markings 551 can be formed on the inoperative region 55 to aid in alignment of the apertures 54 and the units of anodes and cathodes.

The above tetra-polar structure provides the converging electrode layer 51 to converge the electron beam, such that the electron beam can impinge the corresponding phosphors layer 33 precisely. Therefore, the electron beam is prevented from impinging the phosphor layer 33 of the neighboring units. The display effect of the field emission display is thus greatly enhanced. However, as the insulation layer 52 and the gate layer 53 are still fabricated by photolithography process, the process is complicated and the cost is high. Moreover, there need installed multiple strip-type spacers 34 between the anode plate 30 and the converging electrode layer 51. Adhesion is used to attach the spacers 34 which has small size about 50μ to about 200 μm. This type of structure has the fabrication difficulty as follows:

1. Complicated fabrication process: As the spacer 34 is formed very thin, the precision requirement of attaching and transporting equipment for installing the spacer is higher.

2. The adhesion applied to the spacer 34 easily causes contamination: As the conventional spacer 34 is dipped with adhesion paste and subjected to a heating process, the adhesion paste becomes a contamination source during the heating process. Further, the solvent of the adhesion paste may be evaporated in the sintering process to cause secondary contamination.

In addition, in the electric field operation, the surface of the spacer 34 is easily to accumulate charges to form an electric field around, such that the path and impinging effect of the electron beam upon the phosphor layer 33 will be affected.

### BRIEF SUMMARY OF THE INVENTION

The present invention provides a mesh structure of a tetraode field-emission display and a method of fabricating the same. In this invention, the tetra-layer mesh structure including a gate layer, an insulation layer, a converging electrode layer and a glass plate is fabricated by a simpler process, such that the cost is reduced. Moreover, the drawbacks caused by the conventional strip-type spacer structure are prevented.

The mesh structure provided by the present invention is fabricated by processing a glass plate to serve as a spacer and a metal conductive layer to serve as a converging electrode layer, forming glass layer on one surface of the converging electrode layer to serve as an insulation layer, and forming a conductive layer on one exposed surface of the insulation layer to serve as a gate layer. Thereby, the tetra-layer mesh structure is formed.

### BRIEF DESCRIPTION OF THE DRAWINGS

These as well as other features of the present invention will become more apparent upon reference to the drawings therein:

FIG. 1 illustrates a local cross sectional view of a conventional triode field-emission display;

FIG. 2 is a local cross sectional view of a tetra-polar field-emission display;

FIG. 3 is a schematic drawing of a mesh of a tetra-polar field-emission display;

FIG. 4 shows an exploded view of a mesh structure in a first embodiment of the present invention;

FIG. 5 is a perspective view of the mesh structure of FIG. 4 combined with the cathode and anode plates;

FIG. 6 is a perspective view of a mesh structure in a second embodiment of the present invention;

FIG. 7 is a perspective view of a mesh structure in a third embodiment of the present invention; and

FIG. 8 shows a local cross sectional view of the mesh structure in FIG. 7 after the gate layer is formed.

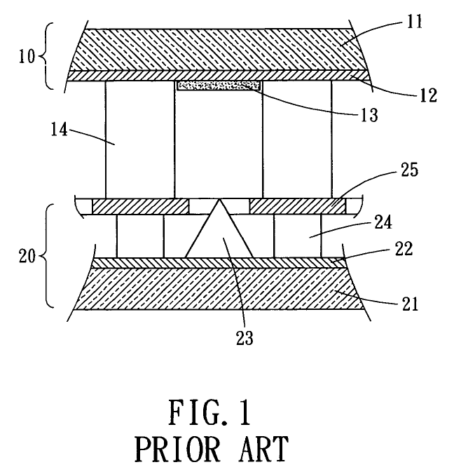

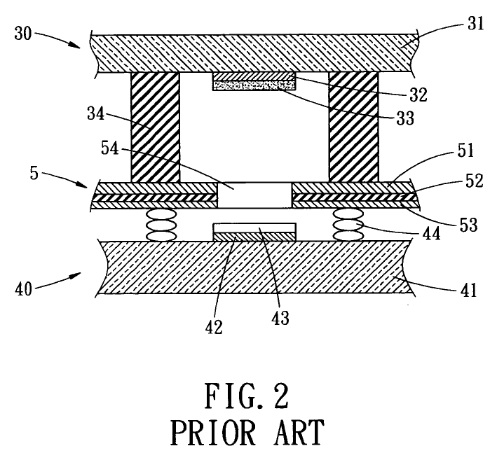

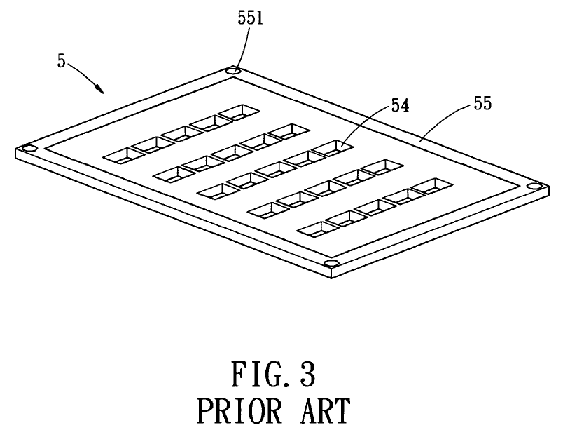

### DETAILED DESCRIPTION OF THE INVENTION

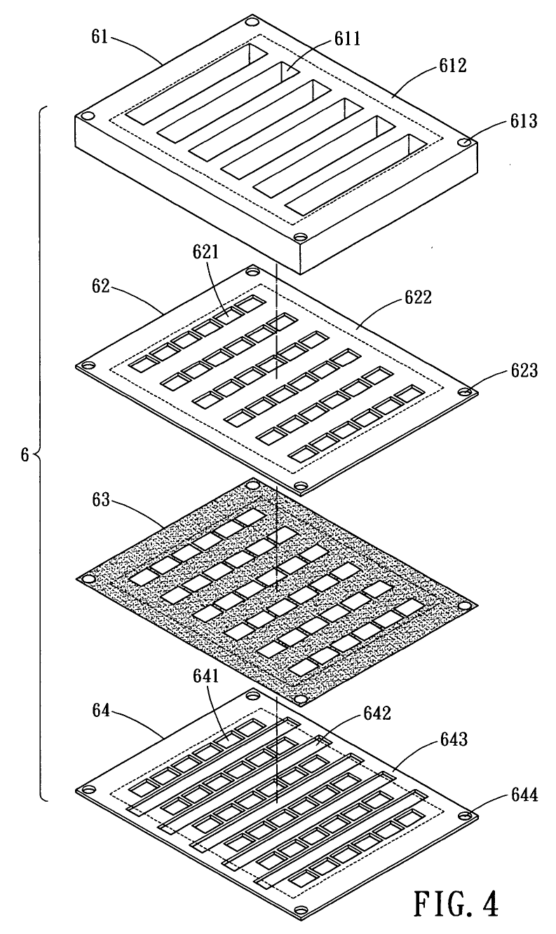

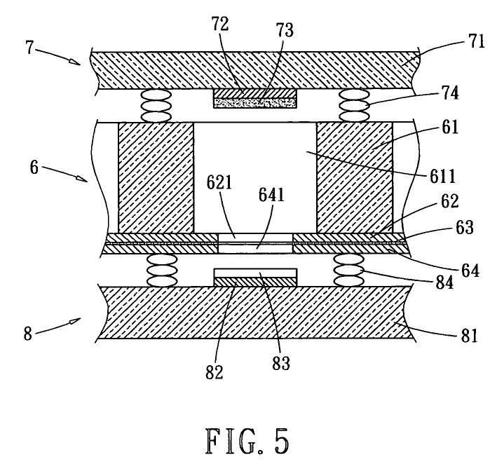

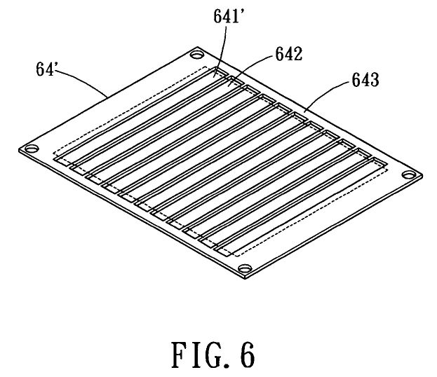

Referring to FIG. 4, an exploded view of a mesh 6 is illustrated. As shown, the mesh is a tetra-layer structure constructed by a glass plate 61, a first conductive layer 62, an insulation layer 63 and a second conductive layer 64. The flat glass plate 61 with a specific thickness serves as a spacer to replace the conventional multiple strip-type spacers. Preferably, the first and second conductive layers 62 and 64 are fabricated from the same metal or conductive material. The first and second conductive layers 62 and 64 serve as a converging electrode layer and a gate layer, respectively. A plurality of apertures 621 is formed to extend through the first conductive plate 62. In this embodiment, the apertures 621 are arranged in a rectangular array. Each of the apertures 621 is to be aligned with a corresponding unit of anode and cathode. The periphery of the first conductive layer 62, that is, the region outside of the dash line as shown in FIG. 4, is an inoperative region 622 to be cut away after the package of the field emission display is complete. The spacing glass plate 61 is located above the first conductive plate 62. Similar to the first conductive layer 62, a plurality of holes 611 is formed to extend through the spacing glass plate 61. The holes 611 are aligned with the apertures 621. Preferably, one hole 611 is formed in correspondence with each aperture 621. Alternatively, the holes 611 may be formed with a larger dimension such that one hole 611 covers the range of more than one aperture 621. For example, as shown in FIG. 4, a plurality of elongate holes 611 is formed in the spacing glass plate 61, such that each elongate hole 611 covers the range of a row or a column of the apertures 621. Similar to the first conductive layer 62, a periphery of the spacing glass plate 61 is the inoperative region 612 to be removed after package. A plurality of markings 613 is formed on the inoperative region 612 to aid in alignment. Below the first conductive plate 62 is formed a glass glue serving as the insulation layer 63 to avoid conduction between the first and the second conductive layers 62 and 64. The second conductive layer 64 serves as the gate layer. A plurality of apertures 641 is formed to extend through the second conductive layer 64. Preferably, one aperture 641 is formed aligned with each aperture 621. Or alternatively as shown in FIG. 6, a plurality of elongate slits 641′ and a plurality of isolation slits 642 are alternately formed to extend through the second conductive layer 64′. Each of the elongate slits 641′ is aligned with a row or a column of the apertures 621. The isolation slits 642 extend across the conductive plate 64′ into the inoperative region 643. Therefore, after the inoperative region 643 is removed, two conductive strips are formed at two elongate sides of each elongate slit 641′. Each pair of the conductive strips constructs an independent conductive path. When any pair of conductive strips is biased with a potential, a gate operative to drain the electron from the cathode unit between the pair of conductive strips is formed. The second conductive layer 64 also includes a peripheral inoperative region 643 and a plurality of alignment markings 644 is formed thereon. These four layers are then packaged to form an independent mesh 6. FIG. 5 shows the cross sectional view of the mesh combined with an anode plate 7 and a cathode plate 8. As shown, the spacing glass plate 61 faces to the anode plate 7 with an insulation wall 74 formed therebetween, and the second conductive plate 64 faces to the cathode plate 8 with an insulation wall 84 formed therebetween. An anode conductive layer 72 and a phosphor layer 73 formed on an anode substrate 71 of the anode plate are located corresponding to a cathode conductive layer 82 and an electron emission source layer 83 formed on a cathode substrate 81 of the cathode plate 8. The apertures 621, 611 and 641 are aligned with each other to establish a path, such that an electron beam generated from the electron emission source layer 83 can propagate towards the phosphors layer 73.

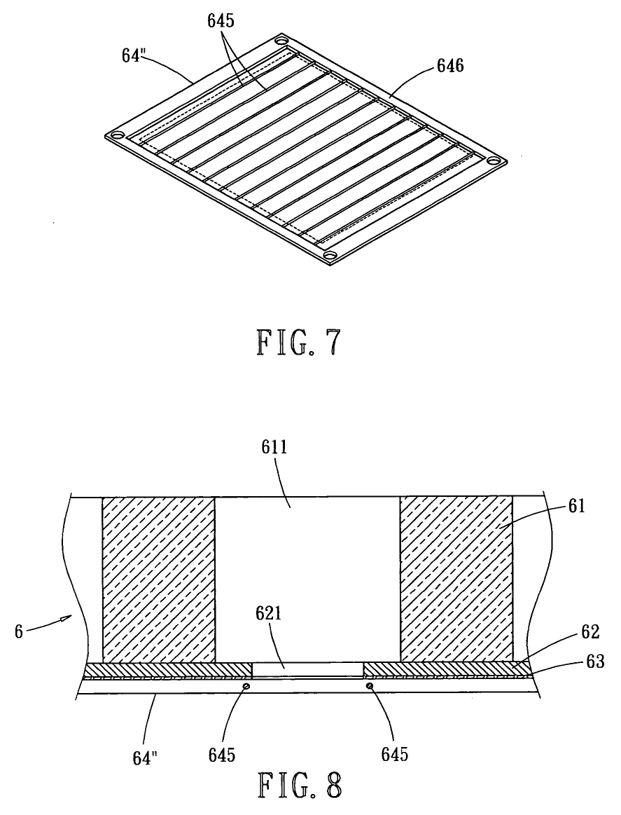

FIG. 7 shows another embodiment of the second conductive layer 64″. As shown, a plurality of parallel conductive lines 645 is formed to extend within a hollow frame 646. The conductive lines 645 are positioned under the first conductive layer 62 between two neighboring rows of the apertures 621. After the inoperative region outside of the dash line is removed, the frame 646 is separate from the conductive lines 645 to form a structure which includes a plurality pair of the conductive lines 645, and each pair of conductive lines 645 sandwiches a row of the first apertures 621, which is equivalent to a row of cathode units as shown in FIG. 8. That is, each pair of the conductive lines 645 serves as a gate.

The fabrication method of the above mesh structure includes selecting the conductive layers 62 and 64 and the glass plate 61 having a thermal coefficient similar to that of the anode plate 7 and the cathode plate 8 to prevent from breakage during high-temperature sintering process for package. An UV glue and a glass glue are applied between the spacing glass plate 61 and the first conductive plate 62 to adhere the spacing glass plate 61 and the first conductive plate 62 by aligning the alignment markings 613, 623 and 633. An ultra-violet light is radiating upon the UV glue for temporally fitting. Further, the insulation layer 63 such as the glass glue is formed on the other side of the first conductive plate 62 by a screen printing process, and the second conductive plate 64, 64′ or 64″ is adhered to the insulation layer 63. Similarly, the UV glue and the glass glue are applied and the alignment markings 613, 623 and 633 are used to stack the insulation layer 63 and the second conductive plate 64, 64′ or 64″. Finally, the temporally fitted mesh 6 is then held by a high-temperature clip and placed into a high-temperature furnace to perform sintering. The UV glue is then vaporized and exhausted due to high temperature. The glass glue then provides permanent fitting of the mesh. Therefore, in substitution of the convention strip-type spacer for fabricating the mesh, the process is simplified, and the cost is reduced.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A mesh structure disposed between a plurality of anode units and cathode units of a tetraode field emission display, comprising:
a first conductive layer to serve as a converging electrode layer having a proximal surface facing the anode units and a distal surface opposing to the proximal surface, the first conductive plate comprising a plurality of first apertures extending therethrough;
a glass plate formed on the proximal surface of the first conductive layer to serve as a spacer, the glass plate including a plurality of second apertures extending therethrough;
an insulation layer formed on the distal surface of the first conductive layer; and
a second conductive layer formed on the insulation layer to serve as a gate electrode layer, the second conductive layer having a proximal surface facing the cathode units and a distal surface opposing to the proximal surface, wherein the second conductive layer includes a plurality of third apertures extending therethrough and aligned with the first and second apertures.

2. The mesh structure of claim 1, wherein each second aperture is aligned with one corresponding first aperture.

3. The mesh structure of claim 1, wherein each second aperture covers an opening range of a plurality of the first apertures.

4. The mesh structure of claim 1, wherein each third aperture is aligned with one corresponding first aperture.

5. The mesh structure of claim 1, wherein each third aperture covers an opening range of a plurality of the first apertures.

6. The mesh structure of claim 1, wherein the insulation layer is a glass glue.

7. A mesh structure of a tetra-polar field-emission display, comprising:
a converging electrode layer having an array of first apertures extending therethrough;
a spacing glass plate located adjacent to one side of the converging electrode layer, the insulation layer having a plurality of second apertures aligned with the first apertures;
an insulation layer formed on the other side of the converging electrode layer; and
a gate layer including a plurality of conductive lines located adjacent to the insulation layer, wherein each of the conductive lines is aligned with a portion of the converging electrode layer between one pair of neighboring rows of the first apertures.

8. The mesh structure of claim 7, wherein the gate layer further comprises a hollow frame within which the conductive lines extend.

9. The mesh structure of claim 7, wherein each of the second apertures is aligned with one corresponding first aperture.

10. The mesh structure of claim 7, wherein each of the second apertures is aligned with a plurality of corresponding first apertures.

11. A method of fabricating a mesh structure mounted between an anode plate and a cathode plate of a tetra-polar field-emission display, comprising:
providing a first conductive plate;
forming a plurality of first apertures extending through the first conductive plate;
providing a glass plate to server as a spacer;
forming a plurality of second apertures extending through the glass plate;
temporally attaching the glass plate to one side of the first conductive plate with the second apertures aligned with the first apertures;
providing an insulation layer formed on the other side of the first conductive plate;
providing a second conductive plate;
forming a plurality of third apertures extending through the second conductive plate;
temporally attaching the second conductive plate to the insulation layer with the third apertures aligned with the first and second apertures; and
permanently stacking the glass plate, the first conductive plate, the insulation plate and the second conductive plate to form the mesh structure.

12. The method of claim 11, wherein the step of temporally attaching the glass plate to the first conductive plate includes applying an ultra-violet glue therebetween.

13. The method of claim 11, wherein the step of temporally attaching the second conductive plate to the insulation layer includes applying an ultra-violet glue therebetween.

14. The method of claim 11, wherein the step of permanently stacking the glass plate, the first conductive plate, the insulation plate and the second conductive plate includes a high-temperature sintering process.

15. The method of claim 11, further comprising providing the first and second conductive layer fabricated from a material having a thermal expansion coefficient similar to that of the anode plate and the cathode plate.

16. The method of claim 11, further comprising providing the glass plate having a thermal expansion coefficient similar to that of the anode plate and the cathode plate.

17. The method of claim 11, wherein the insulation layer is a glass glue.
